(19) United States
(12) Patent Application Publication
(10) Pub. No.: US 2012/0299300 A1
(43) Pub. Date: Nov. 29, 2012

(54) TURBINE GENERATOR SYSTEM

(75) Inventors: Jong-Ian Tsai, Kaohsiung City (TW); Ching-Tai Chiang, Kaohsiung City (TW); Rong-Ching Wu, Kaohsiung City (TW); Chen-Sen Ouyang, Kaohsiung City (TW)

(73) Assignee: I SHOU UNIVERSITY, Kaohsiung City (TW)

(21) Appl. No.: 13/115,313

(22) Filed: May 25, 2011

(51) Int. Cl. H02K 7/18

(52) U.S. Cl. 290/52

(57) ABSTRACT

A turbine generator system is operable to provide electric power to an electric network connected thereto, and includes a turbine generator apparatus and an output module. The turbine generator apparatus includes a turbine rotor provided with a plurality of blades and rotatable to output a mechanical torque, and a generator coupled to the turbine rotor and to be driven by the mechanical torque to generate driving electric power having a system frequency. The output module is electrically connected to the turbine generator apparatus for converting the driving electric power into output electric power to be provided to the electric network. The generator includes a mechanical filter that is operable, when the turbine generator system has a fault, to resonate in a specified frequency that is based on the system frequency to make the blades of the turbine rotor less sensitive to electromagnetic torque disturbance attributed to the fault.

### BACKGROUND OF THE INVENTION

1. Field of the Invention

The present invention relates to a generator system, more particularly to a turbine generator system.

2. Description of the Related Art

Referring to FIG. 1, a conventional turbine generator system 1 is operable to provide electric power to an electric network 5 connected thereto. The conventional turbine generator system 1 includes a steam turbine device 2, a synchronous generator 3, and an output module 4.

The steam turbine device 2 includes a steam boiler 21, and a turbine rotor 22 provided with a plurality of blades 23 that are connected to a shaft 24. The steam boiler 21 is operable to generate steam for pushing the blades 23 of the turbine rotor 22 so that the shaft 24 rotates to output a mechanical torque.

The synchronous generator 3 includes a generator rotor 31, a rectifier rotor 32, and an excitation rotor 33 for generating a magnetic field. The generator rotor 31 is connected to the shaft 24 of the turbine rotor 22, and is driven by the mechanical torque from the shaft 24 to generate driving electric power having a system frequency.

The output module 4 includes a boost transformer 41 electrically connected to the synchronous generator 3, and a pair of transmission sets 40 electrically connected in parallel between the boost transformer 41 and the electric network 5. Each of the transmission sets 40 includes a transmission cable 43, and a pair of circuit breakers 42 that are electrically connected in series through the transmission cable 43. The boost transformer 41 is operable to boost the driving electric power from the synchronous generator 3 so as to generate output electric power to be provided to the electric network 5. In each of the transmission sets 40, the circuit breakers 42 are configured to detect whether the transmission cable 43 has a single-phase to ground fault, to automatically switch from a conducting state to a non-conducting state so as to operate the turbine generator system 1 in a single-pole tripping state when the single-phase to ground fault is detected, and to automatically switch from the non-conducting state to the conducting state so as to resume operation of the turbine generator system 1 in the normal state after the single-phase to ground fault is eliminated.

However, when one of the transmission cables 43 has a single-phase to ground fault, the circuit breakers 42 that are connected to the faulty one of the transmission cables 43 will switch to the non-conducting state resulting in a substantial negative-sequence current flowing into the synchronous generator 3. As a result, the negative-sequence current imposes electromagnetic torque disturbance having a frequency that is twice the system frequency on the blades 23 of the turbine rotor 22 to result in supersynchronous resonance on the blades 23. Such supersynchronous resonance causes torsional vibration on the blades 23 and may even result in breaking of the blades 23.

### SUMMARY OF THE INVENTION

Therefore, an object of the present invention is to provide a turbine generator system capable of reducing vibration of blades of a turbine rotor thereof.

Accordingly, a turbine generator system of this invention is operable to provide electric power to an electric network connected thereto, and comprises a turbine generator apparatus and an output module.

The turbine generator apparatus includes a turbine device and a generator. The turbine device includes a turbine rotor provided with a plurality of blades and rotatable to output a mechanical torque. The generator is coupled to the turbine rotor, and is to be driven by the mechanical torque from the turbine rotor to generate driving electric power having a system frequency. The output module is electrically connected to the turbine generator apparatus for converting the driving electric power into output electric power to be provided to the electric network. The generator includes a mechanical filter that is operable, when the turbine generator system has a fault, to resonate in a specified frequency that is based on the system frequency to make the blades of the turbine rotor less sensitive to electromagnetic torque disturbance attributed to the fault.

According to another aspect, a turbine generator apparatus of this invention comprises a turbine device and a generator.

The turbine device includes a turbine rotor provided with a plurality of blades and rotatable to output a mechanical torque. The generator is coupled to the turbine rotor, and is to be driven by the mechanical torque from the turbine rotor to generate driving electric power having a system frequency. The generator includes a mechanical filter that is operable, when a turbine generator system provided with the turbine generator apparatus has a fault, to resonate in a specified frequency that is based on the system frequency to make the blades of the turbine rotor less sensitive to electromagnetic torque disturbance attributed to the fault.

According to yet another aspect, a synchronous generator of this invention is to be coupled to a turbine device that includes a turbine rotor provided with a plurality of blades and rotatable to output a mechanical torque. The synchronous generator comprises a generator rotor and a mechanical filter.

The generator rotor is to be connected to the turbine rotor, and is to be driven by the mechanical torque from the turbine rotor to generate driving electric power having a system frequency. The mechanical filter is connected to the generator rotor and is operable, when a turbine generator system provided with the turbine device and the synchronous generator has a fault, to resonate in a specified frequency that is based on the system frequency to make the blades of the turbine rotor less sensitive to electromagnetic torque disturbance attributed to the fault.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of a conventional turbine generator system;

FIG. 2 is a block diagram of a preferred embodiment of a turbine generator system according to the present invention;

FIG. 3 is a partly cross-sectional view of an exemplary mechanical filter of the turbine generator system of the preferred embodiment;

FIG. 4 shows an equivalent circuit model of a synchronous generator of the turbine generator system of the preferred embodiment;

FIG. 5 shows a mechanical model of a turbine generator apparatus of the turbine generator system of the preferred embodiment;

FIG. 6 are two plots illustrating torque responses of two blade sets of blade of low-pressure stage steam turbines of a turbine device of the turbine generator system;

FIG. 7a shows electromagnetic disturbing torque and torsional vibration in a turbine generator system without the mechanical filter when the turbine generator system resumes operation in a normal state from a single-pole tripping state;

FIG. 7b shows electromagnetic disturbing torque and torsional vibration in the turbine generator system provided with the mechanical filter according to this invention when the turbine generator system resumes operation in a normal state from the single-pole tripping state;

FIG. 8a shows peak-to-peak torques of rotor blades when the turbine generator system without the mechanical filter resumes operation in the normal state;

FIG. 8b shows peak-to-peak torques of rotor blades when the turbine generator system provided with the mechanical filter according to this invention resumes operation in the normal state;

FIG. 9a shows a relationship between resonant frequencies of the mechanical filter and the peak-to-peak torques of the rotor blades; and

FIG. 9b shows a relationship between the resonant frequencies of the mechanical filter and peak-to-peak torques of various shafts of the turbine generator apparatus of the turbine generator system.

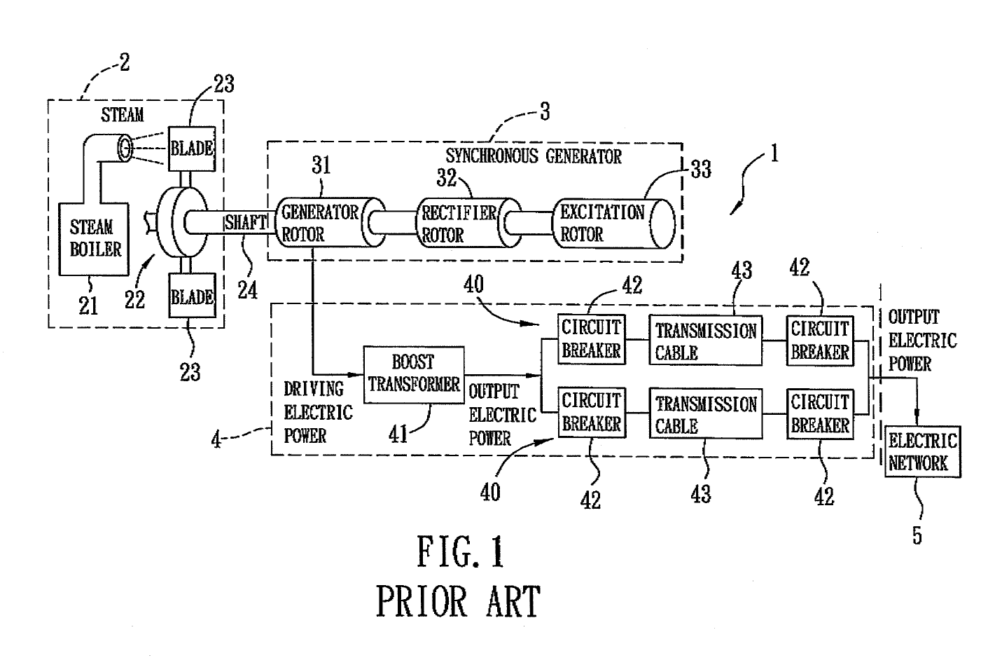

### DETAILED DESCRIPTION OF THE PREFERRED EMBODIMENT

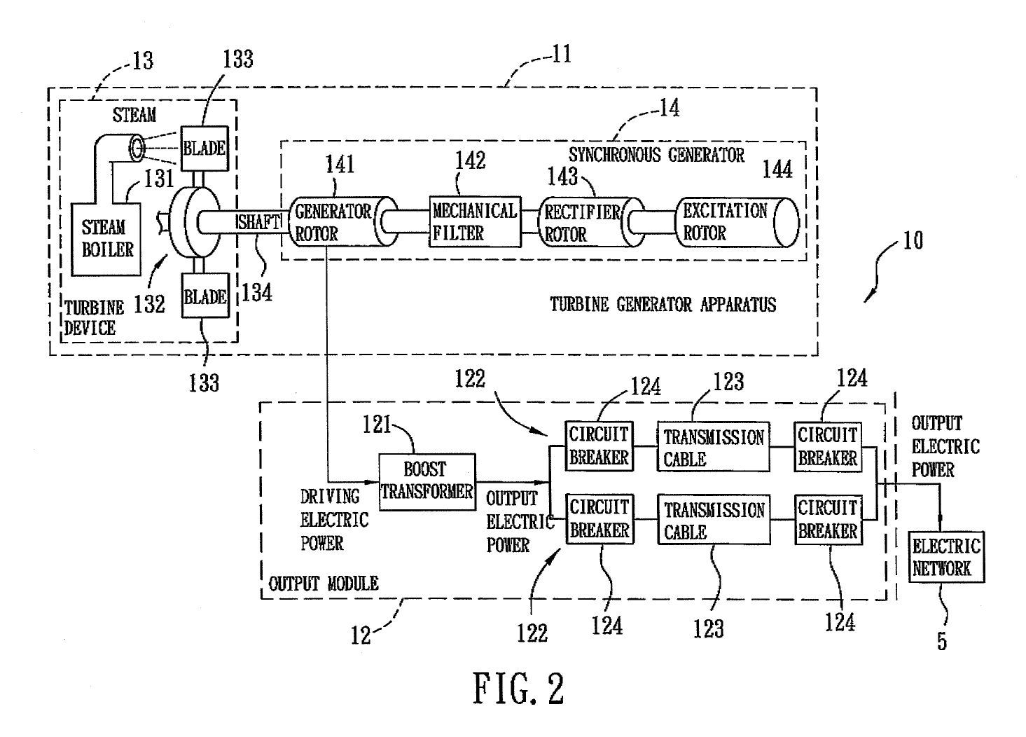

Referring to FIG. 2, the preferred embodiment of a turbine generator system 10 of this invention is operable to provide electric power to an electric network 50 connected thereto. The turbine generator system 10 includes a turbine generator apparatus 11, and an output module 12 electrically connected to the turbine generator apparatus 11. The turbine generator apparatus 11 includes a turbine device 13, and a generator 14 coupled to the turbine device 13.

The turbine device 13 is, for example, a steam turbine, and includes a steam boiler 131 and a turbine rotor 132 provided with a plurality of blades 133 that are connected to a shaft 134. The steam boiler 21 is operable to generate steam for pushing the blades 133 of the turbine rotor 132 so that the shaft 134 rotates to output a mechanical torque.

The generator 14 is a synchronous generator in this embodiment, and is to be driven by the mechanical torque from the turbine rotor 132 to generate driving electric power having a system frequency. The generator 14 includes a generator rotor 141, a mechanical filter 142, a rectifier rotor 143, and an excitation rotor 144. The rectifier rotor 193 is connected to the mechanical filter 142, and is configured to convert alternating current power into direct current power. The excitation rotor 144 is connected to the rectifier rotor 143 for receiving the direct current power therefrom to generate a magnetic field. The generator rotor 141 is connected between the shaft 134 of the turbine rotor 132 and the mechanical filter 142, and is configured to use the magnetic field generated by the excitation rotor 144 to generate alternating current power serving as the driving electric power and as an input to the rectifier rotor 143.

The mechanical filter 142 is configured to have a specified natural frequency that is approximately twice the system frequency, and is operable between a non-resonating mode and a resonating mode. When the turbine generator system 10 operates in a normal state, the mechanical filter 142 is configured to operate in the non-resonating mode in which the mechanical filter 142 does not resonate. Thus, inertia attributed to the mechanical filter 142 in the non-resonating mode is negligible, and has no effect on normal operation of the turbine generator system 10. When the turbine generator system 10 has a fault, the mechanical filter 142 is configured to operate in the resonating mode in which the mechanical filter 142 resonates in a specified frequency that is approximately twice the system frequency, and provides inertia to the generator rotor 141. The inertia thus generated is sufficient to make the blades 133 of the turbine rotor 132 less sensitive to electromagnetic torque disturbance attributed to the fault of the turbine generator system 10 so as to reduce supersynchronous (SPSR) resonance on the blades 133.

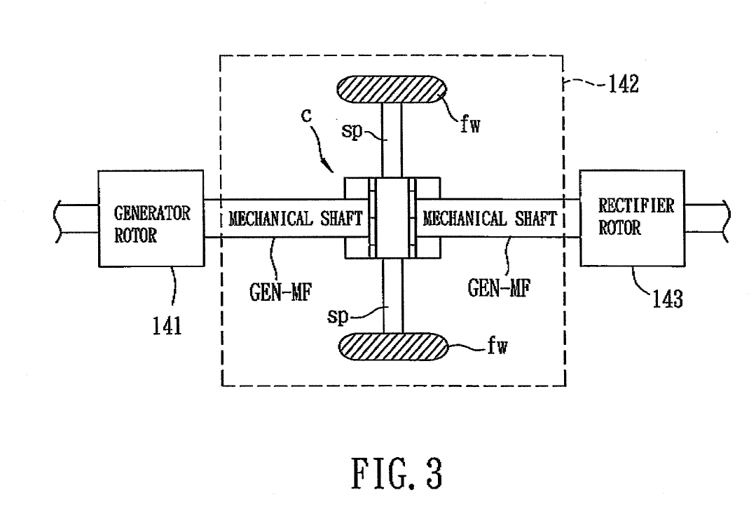

FIG. 3 illustrates an exemplary structure of the mechanical filter 142 that includes a coupler (c) and a flywheel (fw) connected to the coupler (c) through a plurality of spokes (sp). The coupler (c) is mechanically coupled between the generator rotor 141 and the rectifier rotor 143 through a pair of mechanical shafts (GEN-MF), and the flywheel (fw) is rotatable with respect to the mechanical shafts (GEN-MF). Designed with proper inertia constant of the flywheel (fw) and proper stiffness of the mechanical shafts (GEN-MF), the mechanical filter 142 may resonate in the specified frequency that is approximately twice the system frequency. Details of the exemplary structure of the mechanical filter 142 maybe found in “Damping torsional oscillations due to network faults using the dynamic flywheel damper,” IEE Proc.-Gener. Transco. Distrib., Vol. 144, No. 5, pages 495-502, September 1997. It should be noted that the structure of the mechanical filter 142 is not limited to that shown in FIG. 3, and may have a different configuration in other embodiments of the invention.

The output module 12 is electrically connected to the turbine generator apparatus 11 for receiving the driving electric power therefrom and for converting the driving electric power into output electric power to be provided to the electric network 50. The output module 12 includes a boost transformer 121 and a pair of transmission sets 122. The boost transformer 121 is electrically connected to the generator rotor 141 of the generator 14 for receiving the driving electric power therefrom, and is operable to boost the driving electric power so as to generate the output electric power. The transmission sets 122 are electrically connected in parallel between the boost transformer 121 and the electric network 50 for providing the output electric power to the electric network 50.

Each of the transmission sets 122 includes a transmission cable 132 and a pair of circuit breakers 124 that are electrically connected in series through the transmission cable 123 and that are switchable between a conducting state and a non-conducting state. The turbine generator system 10 operates in the normal state when the circuit breakers 124 are in the conducting state, and operates in a single-pole tripping state when the circuit breakers 124 of one of the transmission sets 122 are in the non-conducting state. The circuit breakers 124 of each of the transmission sets 122 are configured to detect whether the transmission cable 123 of a corresponding one of the transmission sets 122 has a single-phase to ground fault. When the single-phase to ground fault is detected, the mechanical filter 142 operates in the resonating mode, and the circuit breakers 124 electrically connected to one of the transmission cables 123 that has the fault are operable to automatically switch from the conducting state to the non-conducting state so as to operate the turbine generator system 10 in the single-pole tripping state. Further, after the single-phase to ground fault is eliminated, the mechanical filter 142 resumes to operate in the non-resonating mode, and the circuit breakers 124 are operable to automatically switch from the non-conducting state to the conducting state so as to resume operation of the turbine generator system 10 in the normal state.

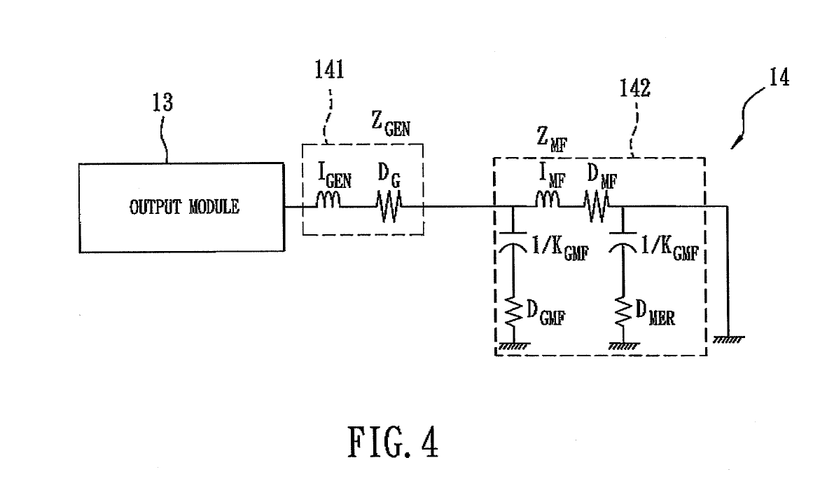

FIG. 4 illustrates an equivalent circuit model of the generator 14. In the equivalent circuit model, the rectifier rotor 143 and the excitation rotor 144 can be treated as a short circuit connected to ground since inertia attributed thereto is small enough to be neglected. Regarding the generator rotor 141, I_{GEN} is the inertia attributed thereto, D_{G} is the damping coefficient thereof, and Z_{GEN} is the impedance provided thereby. Regarding the mechanical filter 142, I_{MF} is the inertia attributed thereto, D_{MF} is the damping coefficient thereof, K_{GMF} is the stiffness coefficient of the mechanical shafts (GEN-MF) of the mechanical filter 142, and Z_{MF} is the impedance provided thereby. Further, D_{GMF} is the damping coefficient between the generator rotor 141 and the mechanical filter 142, and D_{MFR} is the damping coefficient between the mechanical filter 142 and the rectifier rotor 143.

Accordingly, the mechanical filter 142 can be designed as a parallel resonant circuit for providing a very large impedance, combining with the impedance Z_{GEN} provided by the generator rotor 141, when electromagnetic torque disturbance with a frequency that is twice the system frequency attributed to the single-phase to ground fault is imposed on the turbine generator system 10. The combination of the impedance provided by the generator rotor 141 and the mechanical filter 142 makes the blades 133 of the turbine rotor 132 less sensitive to the electromagnetic torque disturbance. Thus, in the equivalent circuit model, voltage drop under the frequency that is twice the system frequency on the blades 133 is reduced. Namely, the SPSR resonance and torsional vibration on the blades 133 are reduced.

For instance, the natural frequency of the mechanical filter 142 for a turbine generator system 10 with four poles and a system frequency of 60 Hz can be obtained based upon the following Equation (1).

$${f}_{osc} = \frac{1}{2 π} \sqrt{\frac{{K}_{GEN - MF}}{{H}_{FW}} \times \frac{377}{4}} \qquad ( 1 )$$

In Equation (1), f_{osc} is the natural frequency of the mechanical filter 142, K_{GEN-MF} is stiffness coefficient of the mechanical shaft (GEN-MF) of the mechanical filter 142 that is connected to the generator rotor 141, and H_{FW} is an inertia constant of the flywheel (fw) of the mechanical filter 142.

Preferably, the natural frequency of the mechanical filter 142 should not be exactly twice the system frequency, i.e., 120 Hz in this case. Since the mechanical filter 142 is a parallel resonant circuit equal to an open circuit in the equivalent circuit model, the mechanical filter 142 resonates in a parallel resonant frequency of 120 Hz if the natural frequency thereof is exactly equal to 120 Hz. The torque of the mechanical shafts (GEN-MF) of the mechanical filter 142 will have a maximum value when the mechanical filter 142 resonates in the parallel resonant frequency. As a result, the mechanical shafts (GEN-MF) may break due to overstress. Therefore, the natural frequency of the mechanical filter 142 should be appropriately shifted from 120 Hz to avoid breaking of the mechanical shafts (GEN-MF).

In the case of the turbine generator system 10 with four poles and a system frequency of 60 Hz, the stiffness coefficient (K_{GEN-MF}) of the mechanical shaft (GEN-MF) is designed as 325.2832 MW/MVA-rad, and the inertia constant (H_{PW}) of the flywheel (fw) is designed as 0.0505 seconds (MW-second/MVA), that is approximately equal to 1/23 of an inertia constant of the generator 14. Thus, the natural frequency of the mechanical filter 142 will be 124 Hz based upon Equation (1).

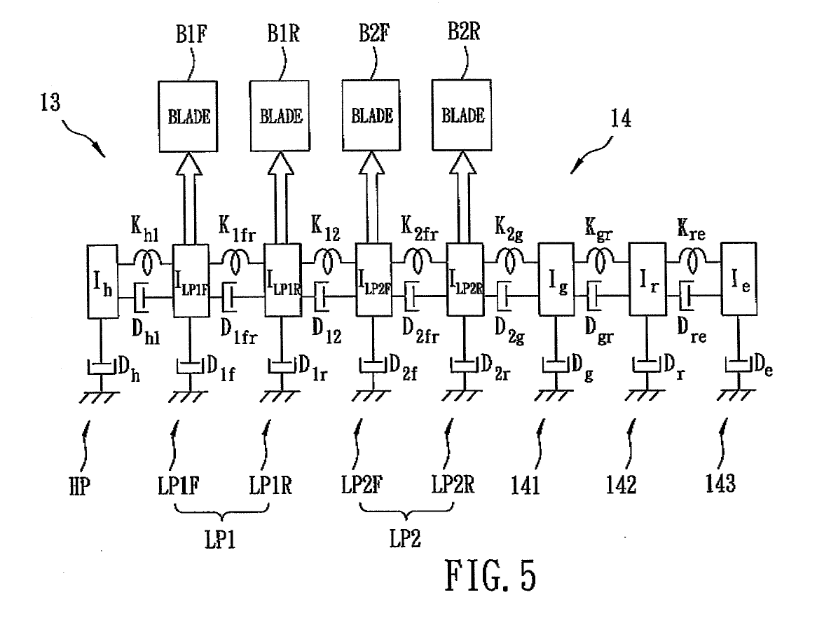

FIG. 5 illustrates a mechanical model of the turbine generator apparatus 11 without the mechanical filter 142. In this embodiment, the generator 14 is a 4-pole synchronous generator with a rated power of 951 MW and a rated revolution speed of 1800 RPM. The turbine device 13 used for driving the generator 14 is a triplex reheating turbine for generating four steam flows, and includes a high-pressure stage steam turbine (HP), a first low-pressure stage steam turbine (LP1) having a front section (LP1F) and a rear section (LP1R), and a second low-pressure stage steam turbine (LP2) having a front section (LP2F) and a rear section (LP2R). Each of the front and rear sections (LP1F, LP1R) of the first low-pressure stage steam turbine (LP1) and the front and rear sections (LP2F, LP2R) of the second low-pressure stage steam turbine (LP2) has a set of blades (B1F, B1R, B2F, B2R) . In particular, each of the sets of blades (B1F, B1R, B2F, B2R) includes eleven blades, first nine blades in each of the sets of blades (B1F, B1R, B2F, B2R) are connected with respective fender, and last two blades in each of the sets of blades (B1F, B1R, B2F, 22R) are a free-type blade.

Regarding the turbine device 13 in FIG. 5, Iₕ and Dₕ are the inertia and the damping coefficient of the high-pressure stage steam turbine (HP), respectively. Kₕ₁ and Dₕ₁ are respectively the stiffness coefficient and the damping coefficient between the high-pressure stage steam turbine (HP) and the front section (LP1F) of the first low-pressure stage steam turbine (LP1). I_{LP1F} and D_{1f} are the inertia and the damping coefficient of the front section (LP1F) of the first low-pressure stage steam turbine (LP1) , respectively. K_{1fr} and D_{1fr} are respectively the stiffness coefficient and the damping coefficient between the front section (LP1F) and the rear section (LP1R) of the first low-pressure stage steam turbine (LP1) . I_{LP1R} and D₁ᵣ are the inertia and the damping coefficient of the rear section (LP1R) of the first low-pressure stage steam turbine (LP1), respectively. K₁₂ and D₁₂ are respectively the stiffness coefficient and the damping coefficient between the rear section (LP1R) of the first low-pressure stage steam turbine (LP1) and the front section (LP2F) of the second low-pressure stage steam turbine (LP2). I_{LP2F} and D_{2f} are the inertia and the damping coefficient of the front section (LP2F) of the second low-pressure stage steam turbine (LP2) , respectively. K_{2fr} and D_{2fr} are respectively the stiffness coefficient and the damping coefficient between the front section (LP2F) and the rear section (LP2R) of the second low-pressure stage steam turbine (LP2). I_{LP2R} and D₂ᵣ are the inertia and the damping coefficient of the rear section (LP2R) of the second low-pressure stage steam turbine (LP2), respectively. K_{2g} and D_{2g} are respectively the stiffness coefficient and the damping coefficient between the rear section (LP2R) of the second low-pressure stage steam turbine (LP2) and the generator rotor 141.

Regarding the generator 14 in FIG. 5, I_{g} and D_{g} are the inertia and the damping coefficient of the generator rotor 141, respectively. K_{gr} and D_{gr} are respectively the stiffness coefficient and the damping coefficient between the generator rotor 141 and the rectifier rotor 143. Iᵣ and Dᵣ are the inertia and the damping coefficient of the rectifier rotor 143, respectively. Kᵣₑ and Dᵣₑ are respectively the stiffness coefficient and the damping coefficient between the rectifier rotor 143 and the excitation rotor 144. Iₑ and Dₑ are the inertia and the damping coefficient of the excitation rotor 144, respectively.

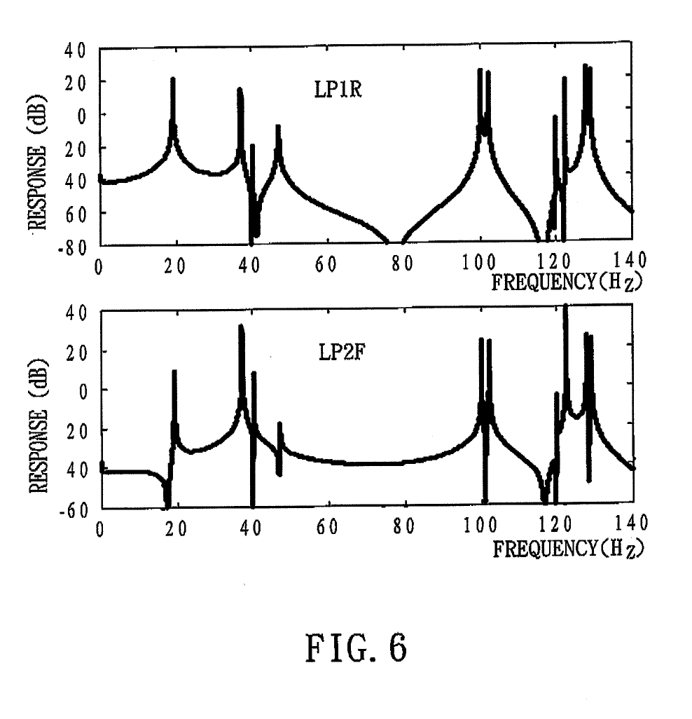

FIG. 6 are two plots illustrating torque responses of the set of blades (B1R) of the rear section (LP1R) of the first low-pressure stage steam turbine (LP1), and torque responses of the set of blades (B2F) of the front section (LP2F) of the second low-pressure stage steam turbine (LP2), respectively, in which the turbine generator apparatus 11 is provided with the mechanical filter 142. As shown in the plots of FIG. 6, peak resonance of the set of blades (B1R) of the rear section (LP1R) of the first low-pressure stage steam turbine (LP1) and the set of blades (52F) of the front section (LP2F) of the second low-pressure stage steam turbine (LP2) under the frequency twice the system frequency (i.e., 120 Hz) is significantly reduced. It should be noted that the function of the mechanical filter 142 is to reduce vibration of the blades 133 so as to protect the blades 133 from fatigue damage, and not to completely eliminate the vibration of the blades 133.

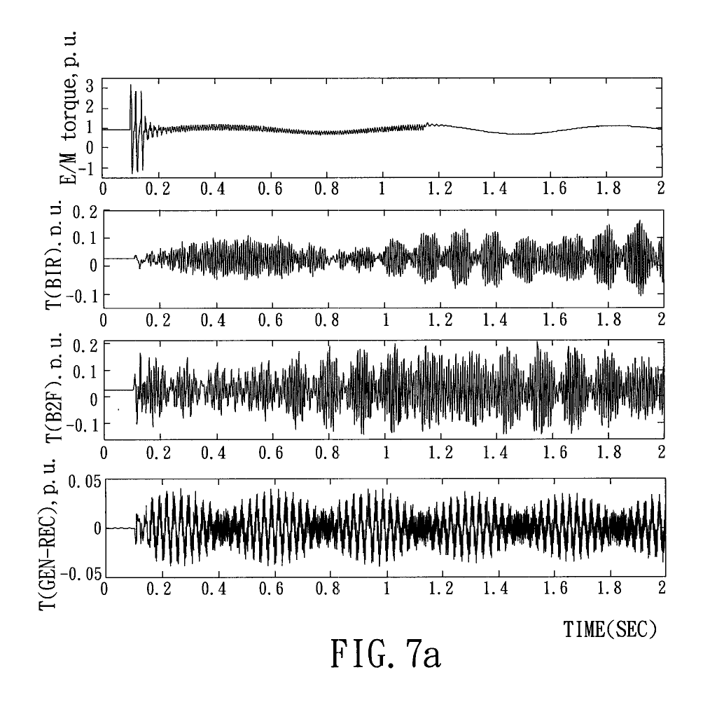

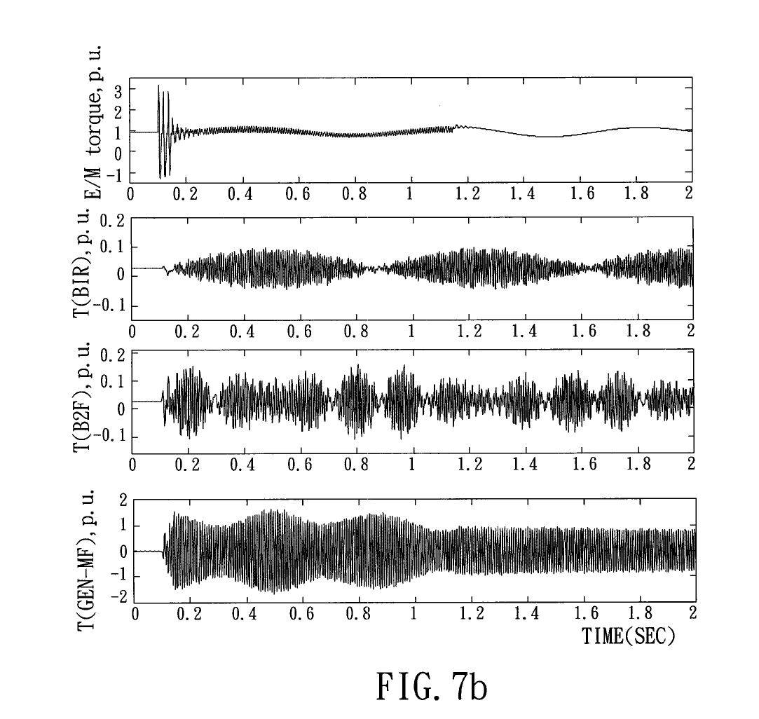

FIG. 7a shows transient responses of the electromagnetic disturbing torque (E/M torque) of the generator 14 without the mechanical filter 142 when the turbine generator system 10 resumes operation in the normal state from the single-pole tripping state. FIG. 7b shows transient responses of the electromagnetic disturbing torque (E/M torque) of the generator 14 provided with the mechanical filter 142 when the turbine generator system 10 resumes operation in the normal state from the single-pole tripping state.

FIG. 7a further shows, during resumed operation of the turbine generator system 10 without the mechanical filter 142 in the normal state, the transient responses of the torsional vibration (T (B1R)) of the set of blades (B1R) of the rear section (LP1R) of the first low-pressure stage steam turbine (LP1), the transient responses of the torsional vibration (T(B2F)) of the set of blades (B2F) of the front section (LP2F) of the second low-pressure stage steam turbine (LP2), and the transient responses of the torsional vibration (T(GEN-REC)) between the generator rotor 141 and the rectifier rotor 143. Similarly, further shown in FIG. 7b are the transient responses of the torsional vibration (T(B1R)) of the set of blades (B1R), the transient responses of the torsional vibration (T(B2F)) of the set of blades (B2F), and the transient responses of the torsional vibration (T(GEN-MF)) between the generator rotor 141 and the mechanical filter 142 during resumed operation of the turbine generator system 10 in the normal state.

From the transient responses of the torsional vibration (T(B1R)) of the set of blades (B1R) of the rear section (LP1R) of the first low-pressure stage steam turbine (LP1) in FIG. 7a, it is apparent that the SPSR resonance occurred in the set of blades (B1R). In particular, amplitudes of the torsional vibration (T(B1R)) of the set of blades (B1R) gradually increased during resumed operation of the turbine generator system 10 in the normal state from the single-pole tripping state. Similarly, the SPSR resonance occurred in the set of blades (B2F) of the front section (LP2F) of the second low-pressure stage steam turbine (LP2).

It can be seen from FIG. 7b that the torsional vibration (T(B1R) T (B2F)) of the set of blades (B1R) of the rear section (LP1R) of the first low-pressure stage steam turbine (LP1) and the set of blades (B2F) of the front section (LP2F) of the second low-pressure stage steam turbine (LP2) is reduced. Also, the increase in the amplitudes of the torsional vibration (T(B1R), T(B2F)) is suppressed. Thus, the SPSR resonance on the set of blades (B1R) and the set of blades (B2F) is reduced.

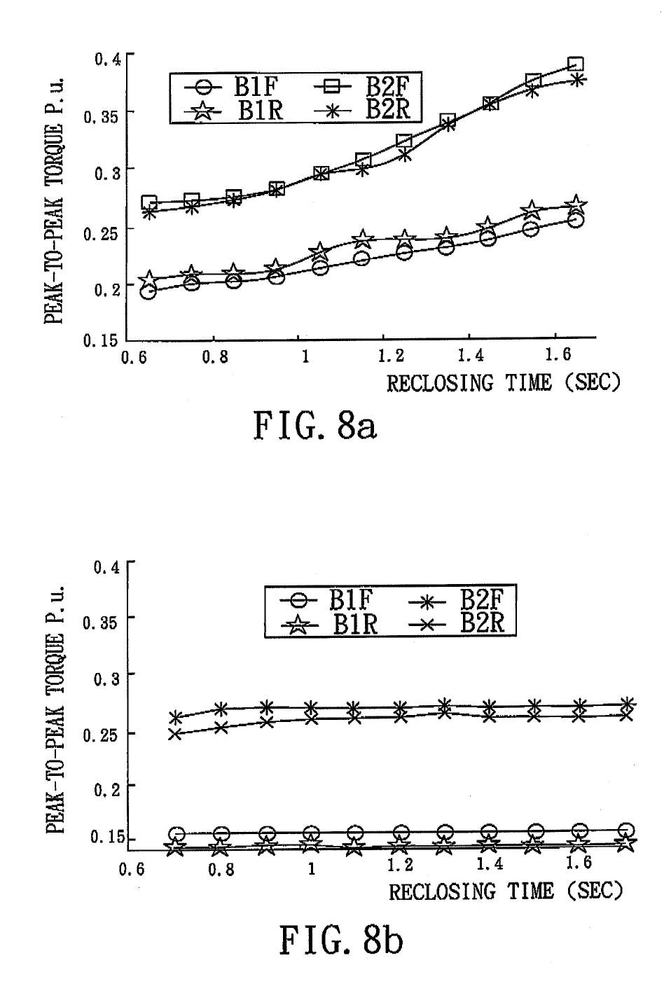

FIG. 8a shows a relationship between peak-to-peak torques of the sets of blades (B1F, B1R, B2F, B2R) and reclosing time during resumed operation of the turbine generator system 10 without the mechanical filter in the normal state. It can be seen that the peak-to-peak torques increased with the reclosing time. FIG. 8b shows a relationship between peak-to-peak torques of the sets of blades (B1F, B1R, B2F, B2R) and the reclosing time during resumed operation of the turbine generator system 10 provided with the mechanical filter 142 in the normal state. The peak-to-peak torques of the sets of blades (BIF, B1R, B2F, B2R) no longer increased with the reclosing time. Therefore, the time in waiting depression of a fault arc is relatively ample so that probability of successful resumption is enhanced.

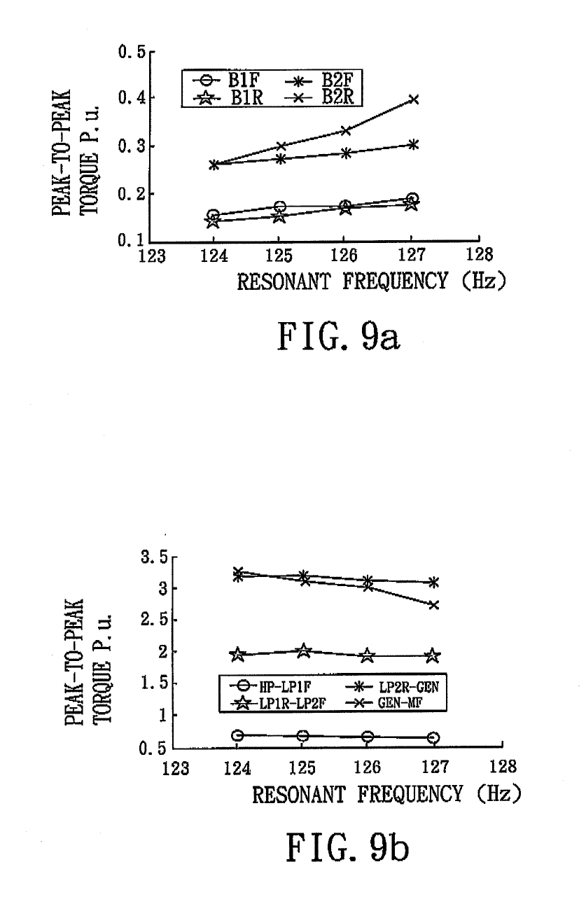

FIG. 9a shows a relationship between the peak-to-peak torques of the sets of blades (B1F, B1R, B2F, B2R) and resonant frequencies of the mechanical filter 142. It can be appreciated that the peak-to-peak torques of the sets of blades (B1F, B1R, B2F, B2R) may be varied with different resonant frequencies of the mechanical filter 142. FIG. 9b shows a relationship between peak-to-peak torques of various shafts of the turbine generator apparatus 11 and the resonant frequencies of the mechanical filter 142. Overstress that results in damage to the mechanical shafts (GEN-MF) of the mechanical filter 142 should be avoided. When the mechanical filter 142 has a resonant frequency of 124 Hz, the peak-to-peak torque of the mechanical shafts (GEN-MF) of the mechanical filter 142 is approximately equal to the peak-to-peak torque of the shaft between the generator 141 and the rectifier rotor 143 in the case without the mechanical filter 142. Therefore, the mechanical filter 142 is designed to have the resonant frequency of 124 Hz.

Since a structure of the blades 133 is quite complicated, it is difficult to improve structural strength of the blades 133 so that the structure of the blades 133 is relatively weaker. In addition, the cost for changing a natural frequency of the blades 133 to avoid the SPSR resonance is relatively high. However, it is relatively easier to enhance the structural strength of the shaft between the generator rotor 141 and the rectifier rotor 143 so that this shaft can be manufactured to have greater structural strength. Therefore, the mechanical filter 142 is provided between the generator rotor 141 and the rectifier rotor 143 for bearing the vibration. Thus, the relatively stronger mechanical shafts (GEN-MF) of the mechanical filter 142 vibrate so as to share and reduce the vibration on the blades 133.

In summary, by virtue of the mechanical filter 142 of this invention, the SPSR resonance on the blades 133 may be alleviated, and the vibration of the blades 133 may be reduced. Thus, the blades 133 may be protected from fatigue damage.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A turbine generator system operable to provide electric power to an electric network connected thereto, said turbine generator system comprising:
a turbine generator apparatus including a turbine device that includes a turbine rotor provided with a plurality of blades and rotatable to output a mechanical torque, and a generator coupled to said turbine rotor and to be driven by the mechanical torque from said turbine rotor to generate driving electric power having a system frequency; and
an output module electrically connected to said turbine generator apparatus for converting the driving electric power into output electric power to be provided to the electric network:
wherein said generator includes a mechanical filter that is operable, when said turbine generator system has a fault, to resonate in a specified frequency that is based on the system frequency to make said blades of said turbine rotor less sensitive to electromagnetic torque disturbance attributed to the fault.

2. The turbine generator system as claimed in claim 1, wherein said generator is a synchronous generator and further includes:
a rectifier rotor connected to said mechanical filter and configured to convert alternating current power into direct current power;
an excitation rotor connected to said rectifier rotor for receiving the direct current power therefrom to generate a magnetic field; and
a generator rotor connected between said turbine rotor and said mechanical filter, and configured to use the magnetic field generated by said excitation rotor to generate alternating current power serving as the driving electric power and as an input to said rectifier rotor.

3. The turbine generator system as claimed in claim 2, wherein said mechanical filter includes a coupler mechanically coupled between said generator rotor and said rectifier rotor through a pair of mechanical shafts, and a flywheel connected to said coupler and rotatable with respect to said mechanical shafts.

4. The turbine generator system as claimed in claim 1, wherein said mechanical filter is configured to resonate in the specified frequency that is approximately twice the system frequency and to provide an impedance for reducing vibration of said blades of said turbine rotor when said turbine generator system has a fault.

5. The turbine generator system as claimed in claim 1, wherein said mechanical filter is configured such that inertia attributed to said mechanical filter is negligible when said turbine generator system operates in a normal state.

6. The turbine generator system as claimed in claim 1, wherein said turbine device is a steam turbine and further includes a steam boiler operable to generate steam for pushing said blades of said turbine rotor, and said turbine rotor further includes a shaft to which said blades are connected, said shaft rotating to output the mechanical torque when said blades are pushed by the steam.

7. The turbine generator system as claimed in claim 1, wherein said output module includes:
a boost transformer electrically connected to said generator for receiving the driving electric power therefrom and operable to boost the driving electric power so as to generate the output electric power; and
a pair of transmission sets to be electrically connected in parallel between said boost transformer and the electric network for providing the output electric power to the electric network, each of said transmission sets including a transmission cable and a pair of circuit breakers that are electrically connected in series through said transmission cable and that are switchable between a conducting state and a non-conducting state;
said turbine generator system operating in a normal state when said circuit breakers are in the conducting state;
said turbine generator system operating in a single-pole tripping state when said circuit breakers of one of said transmission sets are in the non-conducting state;
said circuit breakers of each of said transmission sets being configured to detect whether said transmission cable of a corresponding one of said transmission sets has a single-phase to ground fault, to automatically switch from the conducting state to the non-conducting state so as to operate said turbine generator system in the single-pole tripping state when the single-phase to ground fault is detected, and to automatically switch from the non-conducting state to the conducting state so as to resume operation of said turbine generator system in the normal state after the single-phase to ground fault is eliminated.

8. A turbine generator apparatus, comprising:
a turbine device including a turbine rotor provided with a plurality of blades and rotatable to output a mechanical torque; and
a generator coupled to said turbine rotor and to be driven by the mechanical torque from said turbine rotor to generate driving electric power having a system frequency;
wherein said generator includes a mechanical filter that is operable, when a turbine generator system provided with said turbine generator apparatus has a fault, to resonate in a specified frequency that is based on the system frequency to make said blades of said turbine rotor less sensitive to electromagnetic torque disturbance attributed to the fault.

9. The turbine generator apparatus as claimed in claim 8, wherein said generator is a synchronous generator and further includes:
a rectifier rotor connected to said mechanical filter and configured to convert alternating current power into direct current power:
an excitation rotor connected to said rectifier rotor for receiving the direct current power therefrom to generate a magnetic field; and
a generator rotor connected between said turbine rotor and said mechanical filter, and configured to use the magnetic field generated by said excitation rotor to generate alternating current power serving as the driving electric power and as an input to said rectifier rotor.

10. The turbine generator apparatus as claimed in claim 9, wherein said mechanical filter includes a coupler mechanically coupled between said generator rotor and said rectifier rotor through a pair of mechanical shafts, and a flywheel connected to said coupler and rotatable with respect to said mechanical shafts.

11. The turbine generator apparatus as claimed in claim 8, wherein said mechanical filter is configured to resonate in the specified frequency that is approximately twice the system frequency and to provide an impedance for reducing vibration of said blades of said turbine rotor when the turbine generator system provided with said turbine generator apparatus has a fault.

12. The turbine generator apparatus as claimed in claim 8, wherein said mechanical filter is configured such that inertia attributed to said mechanical filter is negligible when the turbine generator system provided with said turbine generator apparatus operates in a normal state.

13. The turbine generator apparatus as claimed in claim 8, wherein said turbine device is a steam boiler and further includes a steam boiler operable to generate steam for pushing said blades of said turbine rotor, and said turbine rotor further includes a shaft to which said blades are connected, said shaft rotating to output the mechanical torque when said blades are pushed by the steam.

14. A synchronous generator to be coupled to a turbine device that includes a turbine rotor provided with a plurality of blades and rotatable to output a mechanical torque, said synchronous generator comprising:
a generator rotor to be connected to the turbine rotor and to be driven by the mechanical torque from the turbine rotor to generate driving electric power having a system frequency; and
a mechanical filter connected to said generator rotor and operable, when a turbine generator system provided with the turbine device and said synchronous generator has a fault, to resonate in a specified frequency that is based on the system frequency to make the blades of the turbine rotor less sensitive to electromagnetic torque disturbance attributed to the fault.

15. The synchronous generator as claimed in claim 14, further comprising:
a rectifier rotor connected to said mechanical filter and configured to convert alternating current power into direct current power; and
an excitation rotor connected to said rectifier rotor for receiving the direct current power therefrom to generate a magnetic field;
said generator rotor being configured to use the magnetic field generated by said excitation rotor to generate alternating current power serving as the driving electric power and as an input to said rectifier rotor.

16. The synchronous generator as claimed in claim 15, wherein said mechanical filter includes a coupler mechanically coupled between said generator rotor and said rectifier rotor through a pair of mechanical shafts, and a flywheel connected to said coupler and rotatable with respect to said mechanical shafts.

17. The synchronous generator as claimed in claim 14, wherein said mechanical filter is configured to resonate in the specified frequency that is approximately twice the system frequency and to provide an impedance for reducing vibration of the blades of the turbine rotor when the turbine generator system has a fault.

18. The synchronous generator as claimed in claim 14, wherein said mechanical filter is configured such that inertia attributed to said mechanical filter is negligible when the turbine generator system operates in a normal state.
